(19) United States
(12) Patent Application Publication
(10) Pub. No.: US 2007/0126237 A1
(43) Pub. Date: Jun. 7, 2007

(54) Fluid-driven lighting device

(76) Inventors: Jung-Huang Liao, Jhubei City (TW); Yuh-Ren Lee, Jhubei City (TW); Ling-Chia Weng, Yijhu Township (TW)

Correspondence Address: PRO-TECHTOR INTERNATIONAL SERVICES, 20775 NORADA CT., SARATOGA, CA, 95070, US

(21) Appl. No.: 11/449,234

(22) Filed: Jun. 6, 2006

(30) Foreign Application Priority Data
Dec. 6, 2005 (TW) 94143050

(51) Int. Cl. F03B 13/00; F03B 13/10; H02P 9/04

(52) U.S. Cl. 290/43

(57) ABSTRACT

A fluid-driven lighting device comprises a main body, shaped like a cylinder, having a first end connected with a water supply pipe and a second end connected with a sprinkler head, an electric generator, mounted on the main body and further comprising a turbine wheel, placed inside the main body and driven by a flow of liquid the main body, and a generator unit, driven by the turbine wheel and generating an electric current; and at least one lighting unit, set on the main body and emitting light, wherein liquid flows through the main body, causing the electric generator to generate an electric current which in turn supplies the lighting unit for emitting light.

### BACKGROUND OF THE INVENTION

1. Field of the Invention

The present invention relates to a fluid-driven lighting device, particularly to a fluid-driven lighting device used in conjunction with a water sprinkling apparatus.

2. Description of Related Art

With rising quality of life, people living in prosperous cities seek places of rest to gain breathing space and some naturally green spots within widespread gray color of urban areas.

Public parks, courtyards, gardens and recreational areas in company premises are provided with trees and other plants. For keeping green areas fresh, regular sprinkling of water is required. With rising labor costs, automatic sprinkling apparatuses increasingly replace manual sprinkling. At nighttime, multi-colored illumination of bushes or reeds creates a varying and relaxing atmosphere.

As shown in FIGS. 5-6, a conventional water sprinkling apparatus with illuminating function comprises a sprinkling unit 91 with a battery 92 and solar panels 93, distributed over an outer surface, and an illuminating unit 94, mounted on the sprinkling unit 91 and covered by a transparent shade. The solar panels 93 receive solar radiation during daytime, charging the batteries 92. After nightfall, the battery 92 provides energy for the illuminating unit 94 to emit light.

Thus in conventional art, solar energy is employed to produce illumination. Energy is restocked at daylight. If illumination during daytime is turned on, energy is used at that time and not available later. For storing solar energy, storing elements, like batteries or capacitors are required, which add to volume. Furthermore, complexity and manufacturing as well as environmental costs increase.

### SUMMARY OF THE INVENTION

An object of the present invention is to provide a fluid-driven lighting device which illuminates a park or a garden with bright colors.

Another object of the present invention is to provide a fluid-driven lighting device which does not require an external power supply or batteries, so that adverse environmental effects are minimized.

A further object of the present invention is to provide a fluid-driven lighting device which is applicable to a shower head or a similar device.

The present invention can be more fully understood by reference to the following description and accompanying drawings.

### DETAILED DESCRIPTION OF THE PREFERRED EMBODIMENTS

As shown in FIGS. 1-3, the fluid-driven lighting device of the present invention comprises: a main body 10, shaped like a cylinder, an electric generator 20, mounted on the main body 10 and generating electricity from liquid flow; and at least one lighting unit 30 for generating light. When liquid flows through the main body 10, an electric current is generated by the electric generator 20, supplying the lighting unit 30 with power, so that bright light is emitted for illuminating a park or a garden. In the following, a detailed description is given.

The main body 10 is set on a sprinkling apparatus, having a first end 11 connected to a water supply pipe and a second end 12 to which a sprinkling head is attached. The first and second ends 11, 12 are replaceable to adapt to water supply pipes and sprinkling heads of various diameters.

The electric generator 20 is mounted on the main body 10 and generates electricity from liquid that flows through. The electric generator 20 comprises a turbine wheel 21, placed eccentrically, concentrically or axially in a stream of liquid and driven thereby, and a generator unit 22 which, driven by the turbine wheel 21, produces direct or alternating electric current. The turbine wheel 21 preferably has a rotor of the generator unit 22 integrated to produce an electric current. Alternatively, the turbine wheel 21 drives the generator unit 22 electromagnetically.

The turbine wheel 21 is driven by a pressure difference of liquid flowing through, so that no external power supply is required, minimizing adverse environmental effects.

For adjusting current output of the generator unit 22, the electric generator 20 further has an adjusting element 23. A light sensor 24 senses external light intensity for switching the lighting unit 30 on and off, avoiding unnecessary emission of light and thereby extending the lifetime thereof.

The lighting unit 30 is mounted on the main body 10 and is variable in shape and color. For increased effect, a control chip 32 switches between colors and glittering effects according to a pre-settable program or randomly, meeting market demands. A turning device 33, which is controlled by the control chip 32, allows to vary azimuthal and inclination angles.

The lighting unit 30 is provided with a lamp or a light-emitting diode.

Referring to FIG. 3, the generator unit 22 is a compact brushless generator, voltage or current output of which is controlled by the controlling chip 32.

Referring to FIG. 4, the present invention is further applicable to a showering head, allowing in the case of power failure to finish showering unimpeded.

As above explanation shows, when liquid flows through the main body 10, rotation of the turbine wheel 21 is driven and transmitted to the generator unit 22, which subsequently produces an electric current supplying the lighting unit 30. Output of the lighting unit 30 is controlled by the control chip 32 and movement of the turning device 33. Therefore, not only bright light and color effects are attainable, but also no external power supply is required, so that a simple and inexpensive structure is achieved for convenient and economical use.

### BRIEF DESCRIPTION OF THE DRAWINGS

FIG. 1 is a perspective view of the fluid-driven lighting device of the present invention.

FIG. 2 is a perspective view of the fluid-driven lighting device of the present invention when disassembled.

FIG. 3 is a circuit diagram of the present invention.

FIG. 4 is a perspective view of the fluid-driven lighting device of the present invention in the second embodiment

FIGS. 5-6 (prior art) are perspective and side views of a conventional sprinkling apparatus with illuminating function.

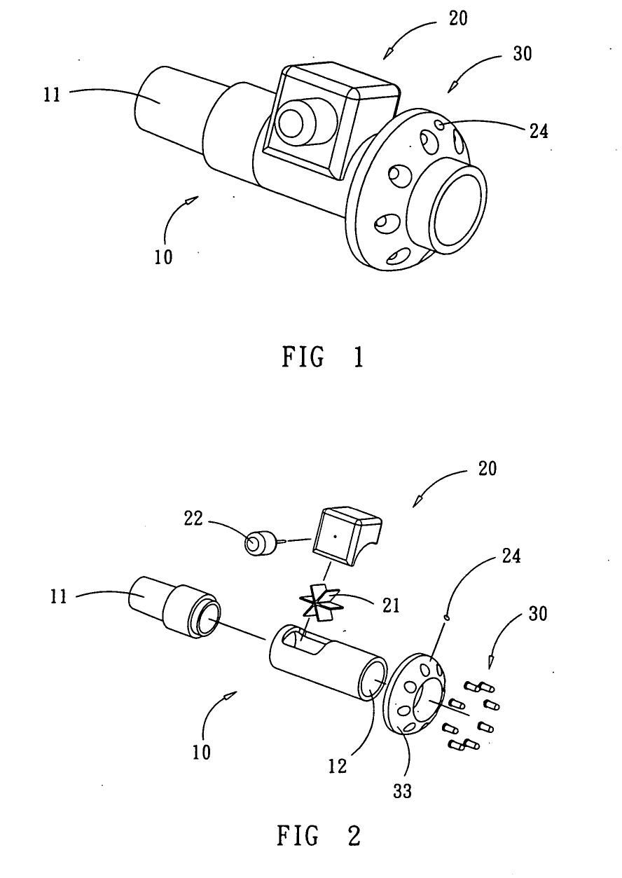

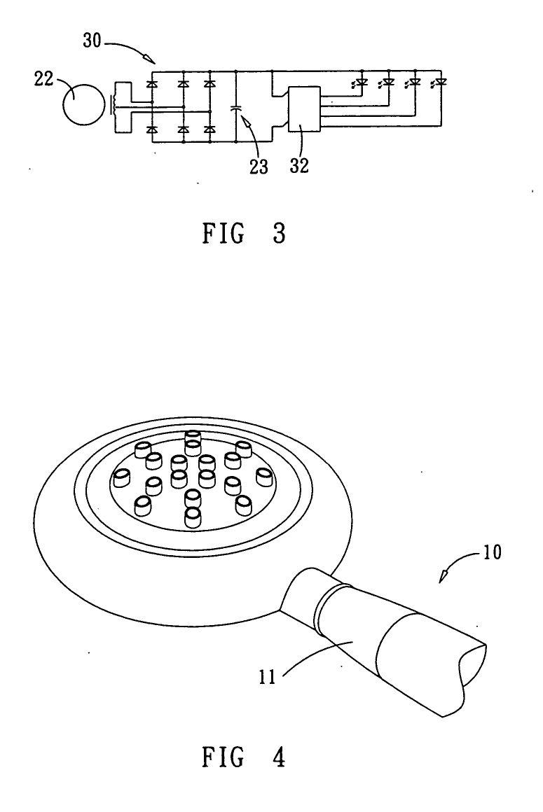

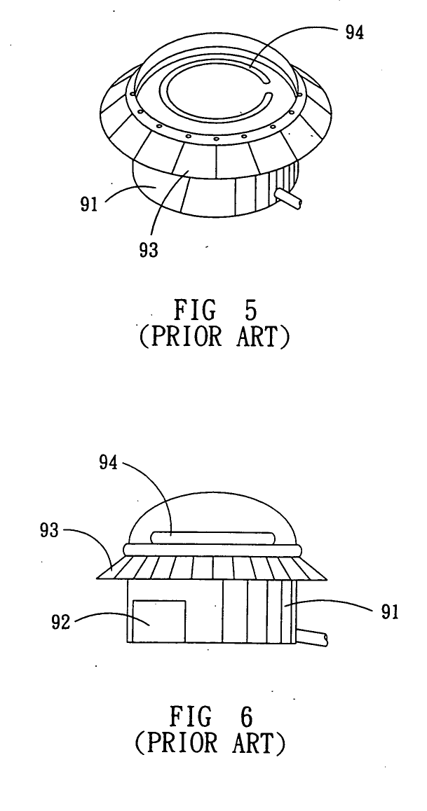

1. A fluid-driven lighting device, comprising
a main body, shaped like a cylinder, having a first end connected with a water supply pipe and a second end connected with a sprinkler head;
an electric generator, mounted on said main body and further comprising:
a turbine wheel, placed inside said main body and driven by a flow of liquid through said main body; and
a generator unit, driven by said turbine wheel and generating an electric current; and
at least one lighting unit, set on said main body and emitting light;
wherein liquid flows through said main body, causing said electric generator to generate an electric current which in turn supplies said lighting unit for emitting light.

2. The fluid-driven lighting device according to claim 1, wherein said first end is replaceable to adapt to water supply pipes of various diameters.

3. The fluid-driven lighting device according to claim 1, wherein said second end is replaceable to adapt to sprinkling heads of various diameters.

4. The fluid-driven lighting device according to claim 1, wherein said electric generator is provided with an adjusting element.

5. The fluid-driven lighting device according to claim 1, wherein said electric generator is provided with a light sensor.

6. The fluid-driven lighting device according to claim 1, wherein said turbine wheel is eccentrically mounted.

7. The fluid-driven lighting device according to claim 1, wherein said turbine wheel is concentrically mounted.

8. The fluid-driven lighting device according to claim 1, wherein said turbine wheel is axially mounted.

9. The fluid-driven lighting device according to claim 1, wherein a rotor of said generator unit is integrated with said turbine wheel.

10. The fluid-driven lighting device according to claim 1, wherein said turbine wheel drives said generator unit electromagnetically.

11. The fluid-driven lighting device according to claim 1, wherein said lighting unit is a lamp.

12. The fluid-driven lighting device according to claim 1, wherein said lighting unit is a light-emitting diode.

13. The fluid-driven lighting device according to claim 1, wherein said lighting unit has varying shapes.

14. The fluid-driven lighting device according to claim 1, wherein said lighting unit emits light of varying colors.

15. The fluid-driven lighting device according to claim 1, wherein said lighting unit is provided with a control chip.

16. The fluid-driven lighting device according to claim 1, wherein said lighting unit is provided with a turning device.

17. The fluid-driven lighting device according to claim 1, wherein said main body is connected with a water sprinkling apparatus.

18. The fluid-driven lighting device according to claim 1, wherein said main body is connected with a shower head.

19. The fluid-driven lighting device according to claim 18, wherein said main body is connected with a similar device for likewise applications.
